(19) United States
(12) Patent Application Publication
(10) Pub. No.: US 2026/0281669 A1
(43) Pub. Date: Sep. 17, 2026

(54) Hybrid Communication Techniques Using Multiple Non-Terrestrial Network Carriers

(71) Applicant: Boost SubscriberCo L.L.C., Englewood, CO (US)

(72) Inventors: David Zufall, Littleton, CO (US); In-Kyung Kim, Highlands Ranch, CO (US); Munira Jaffar, Vienna, VA (US)

(21) Appl. No.: 19/563,553

(22) Filed: Mar. 11, 2026

Related U.S. Application Data
(60) Provisional application No. 63/770,871, filed on Mar. 12, 2025.

(51) Int. Cl. H04W 4/14; H04W 84/06

(52) U.S. Cl. CPC H04W 4/14; H04W 84/06

(57) ABSTRACT

Systems and methods are provided for hybrid satellite communications using multiple non-terrestrial network (NTN) carriers. A user equipment (UE) can be registered for communication via both an NTN Internet-of-Things (IoT) carrier and an NTN New Radio (NR) carrier. The system registers to perform information management system (IMS) messaging via the NTN-NR carrier and short message service (SMS) messaging over non-access stratum (NAS) via the NTN-IoT carrier. Messaging can be performed with the UE by selecting between the available carriers based on bandwidth requirements, user input, or signal availability. A satellite messaging interworking function (SM-IWF) may parse messages to deliver deliverable components (e.g., text) over a narrowband carrier while storing undeliverable components (e.g., video or static images) for later delivery when the UE regains access to a high-bandwidth NTN-NR or terrestrial carrier.

### CROSS-REFERENCE TO RELATED APPLICATIONS

This patent application claims the benefit of priority to U.S. Provisional Application No. 63/770,871, filed Mar. 12, 2025, entitled “Communications using NTN-NR and NTN-IoT,” the entire contents of which are hereby incorporated by reference for all purposes.

### BACKGROUND

Mobile network operators may partner with satellite network companies to extend network coverage. The network coverage can be extended to include both terrestrial networks (TNs) and non-terrestrial networks (NTNs). TNs use ground-based infrastructure (e.g., cell towers, antennas, and radio units) for communications, whereas NTNs use non-ground-based infrastructure (e.g., satellites, uncrewed aircraft systems (UAS), high altitude platforms (HAPs) which may be referred to herein as “NTN communication devices”) for communications. NTNs have a number of challenges compared to TNs. For example, satellites operating at altitude generally have longer latency compared to base stations of TNs. Satellite systems are also power limited. The size of a geographic area covered by a satellite beam of an NTN tends to be larger than a cell of a TN. This difference can lead to higher variations of the propagation delays and stronger far field effects. Additionally, it can be more challenging to communicate between a cell phone and a satellite compared to using a dedicated satellite phone. For example, cell phones typically have less available power and may not include antennas that are specifically designed to acquire and maintain satellite signals compared to a dedicated satellite communication device.

### SUMMARY

A method for performing hybrid satellite communications is provided in some embodiments. A computer system can register user equipment (UE) for communication via a non-terrestrial network (NTN) Internet-of-Things (IoT) carrier. The computer system can register the UE for communication via an NTN New Radio (NR) carrier. The computer system can register to perform information management system (IMS) messaging via the NTN-NR carrier. The computer system can register to perform short message service (SMS) messaging over non-access stratum (NAS) via the NTN-IoT carrier. Messaging can be performed with the UE via the NTN-IoT carrier and the NTN-NR carrier.

Each of the following features can be separately incorporated as part of the method or can be incorporated together with one or more other following features. The NTN-IoT carrier can be located in a guard band of a frequency allocation used for the NTN-NR carrier. A frequency range within the guard band can be reserved to separate the NTN-IoT carrier from an adjacent frequency allocation. Selecting between the NTN-IoT carrier and the NTN-NR carrier based on bandwidth can be performed. Messaging can be performed by the UE via the NTN-IoT carrier unless user input is received to select the NTN-NR carrier. Registering the UE for communication via the NTN-IoT carrier and the NTN-NR carrier can be performed in response to the UE detecting that communication with a terrestrial network (TN) is not available. A satellite messaging interworking function (SM-IWF) system can perform registration for IMS messaging via the NTN-NR carrier. The SM-IWF system can notify a sender of a message that video content was unable to be delivered to the UE. The SM-IWF system can store the video content for later delivery to the UE via a terrestrial network. A received message can be parsed to obtain only an SMS component. Only the SMS component can be delivered to the UE. An undeliverable component of the received message can be stored by the SM-IWF system for later delivery to the UE via either the NTN-NR carrier or a terrestrial network.

A system for performing hybrid satellite communications is provided in some embodiments. The system can comprise one or more processors. The system can comprise a non-transitory processor-readable medium comprising processor-readable instructions. The instructions can be configured to cause the one or more processors to register user equipment (UE) for communication via a non-terrestrial network (NTN) Internet-of-Things (IoT) carrier. The instructions can be configured to cause the one or more processors to register the UE for communication via an NTN New Radio (NR) carrier. The instructions can be configured to cause the one or more processors to register to perform information management system (IMS) messaging via the NTN-NR carrier. The instructions can be configured to cause the one or more processors to register to perform short message service (SMS) messaging over non-access stratum (NAS) via the NTN-IoT carrier. The instructions can be configured to cause the one or more processors to perform messaging with the UE via the NTN-IoT carrier and the NTN-NR carrier.

Each of the following features can be separately incorporated as part of the system or can be incorporated together with one or more other following features. The NTN-IoT carrier can be located in a guard band of a frequency allocation used for the NTN-NR carrier. A frequency range within the guard band can be reserved to separate the NTN-IoT carrier from an adjacent frequency allocation. The one or more processors can be further configured to select between the NTN-IoT carrier and the NTN-NR carrier based on bandwidth. Messaging can be performed by the UE via the NTN-IoT carrier unless user input is received to select the NTN-NR carrier. The registration of the UE for communication via the NTN-IoT carrier and the NTN-NR carrier can be performed in response to the UE detecting that communication with a terrestrial network (TN) is not available. The system can comprise a satellite messaging interworking function (SM-IWF) system. Registering to perform IMS messaging via the NTN-NR carrier can comprise the SM-IWF system performing registration. The instructions can be further configured to cause the one or more processors to notify, via the SM-IWF system, a sender of a message that video content was unable to be delivered to the UE.

In some embodiments, a non-transitory processor-readable medium is provided and can comprise processor-readable instructions configured to cause one or more processors to perform various operations. User equipment (UE) can be registered for communication via a non-terrestrial network (NTN) Internet-of-Things (IoT) carrier. The UE can be registered for communication via an NTN New Radio (NR) carrier. Registration can be performed to support information management system (IMS) messaging via the NTN-NR carrier. Registration can be performed to support short message service (SMS) messaging over non-access stratum (NAS) via the NTN-IoT carrier. Messaging can be performed with the UE via the NTN-IoT carrier and the NTN-NR carrier.

A non-transitory processor-readable medium can comprise processor-readable instructions configured to cause one or more processors to perform operations. A received message can be parsed to obtain only an SMS component. Only the SMS component can be delivered to a user equipment (UE) via a non-terrestrial network (NTN) Internet-of-Things (IoT) carrier. An undeliverable component of the received message can be stored by a satellite messaging interworking function (SM-IWF) system for later delivery to the UE via either an NTN New Radio (NR) carrier or a terrestrial network.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a satellite communication system.

FIG. 2 illustrates an embodiment of a satellite communicating with UE using both NTN-New Radio (NTN-NR) and NTN-Internet of Things (NTN-IoT) communication protocols.

FIG. 3 illustrates an embodiment of satellite cells produced by a satellite using both NTN-NR and NTN-IoT communication protocols.

FIG. 4 illustrates an embodiment of a bandwidth plan for uplink communications and downlink communications.

FIG. 5 illustrates an embodiment of a user link budget for a UE.

FIG. 6 illustrates an embodiment of configuring NTN-IoT carriers in the sidebands of an NTN-NR signal.

FIG. 7 illustrates an embodiment of system architecture of an O-RAN.

FIG. 8 illustrates an embodiment of system architecture of a 5G O-RAN.

FIG. 9 illustrates an embodiment of a communication system that uses NTN-NR and NTN-IoT, in accordance with the present disclosure.

FIG. 10 illustrates an embodiment of a method for using hybrid NTN-IoT and NTN-NR communications.

FIG. 11 illustrates another embodiment of a method for using hybrid NTN-IoT and NTN-NR communications.

FIG. 12 illustrates an embodiment of a method for using an NTN-NR carrier to perform messaging.

FIG. 13 illustrates an embodiment of a method for messaging via an NTN-IoT carrier.

FIG. 14 illustrates an embodiment of a method for performing NTN-NR operations.

FIG. 15 illustrates an embodiment of a method for using an NTN-IoT for communication by default.

### DETAILED DESCRIPTION

The present disclosure provides systems, devices, and methods that generally relate to communications using NTN-NR and NTN-IoT. Satellite systems can be power limited. To service a given geographic area, power limitation can be more severe when the number of satellites allocated to service the given geographic area is few since the satellite power needs to be divided among the larger number of beams (cells) needed to cover each part of the geographic area. The power available for the beam can control the effective bandwidth for the beam and, therefore, the capacity of the cell.

Embodiments described herein provide systems and methods for implementing hybrid communication techniques that utilize multiple non-terrestrial network (NTN) carriers. By integrating both NTN New Radio (NTN-NR) and NTN Internet-of-Things (NTN-IoT) protocols, the communication system can provide a robust and scalable service that adapts to varying signal conditions and bandwidth requirements. This hybrid approach ensures that a user equipment (UE) maintains connectivity for essential services, such as messaging, even in power-limited satellite environments where high-bandwidth synchronization signals may be difficult to acquire.

In one aspect, the system manages a seamless transition between communication protocols based on the specific type of data being transmitted or the current network coverage. For instance, the UE may register for internet multimedia subsystem (IMS) messaging via the NTN-NR carrier for high-bitrate data, while also having registered for short message service (SMS) over non-access stratum (NAS) via the NTN-IoT carrier to ensure a reliable fallback for text-based communication. A satellite messaging interworking function (SM-IWF) coordinates these dual registrations, acting as a proxy to deliver messages across the most appropriate available carrier, thereby optimizing satellite power consumption and improving the overall user experience in non-terrestrial environments.

The system further provides for intelligent message handling and storage to ensure that rich multimedia content is not lost when bandwidth is constrained. When a user equipment is attached to a low-bandwidth carrier, such as an NTN-IoT carrier, the satellite messaging interworking function may parse incoming multimedia messages to extract and deliver only the text-based components. Simultaneously, any high-bandwidth components, such as video files or high-resolution images, that are currently undeliverable are stored within the system. Upon a determination that the user equipment has regained access to a high-bandwidth connection—whether through an NTN-NR carrier or a terrestrial network—the system notifies the interworking function of the device's reachability and automatically initiates the delivery of the outstanding multimedia components. This selective delivery and storage mechanism ensures continuous communication for critical text alerts while preserving the integrity of multimedia data for eventual delivery.

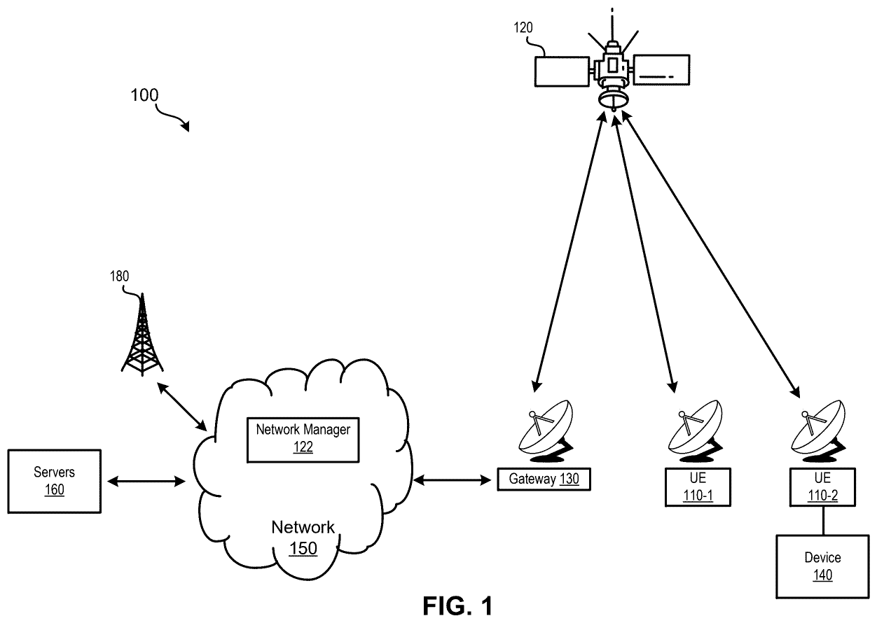

Further detail regarding such embodiments is provided in relation to the figures. FIG. 1 illustrates a satellite communication system 100. The system can include a satellite gateway 130, a satellite 120, UEs 110 (e.g., UE 110-1, UE 110-2), and servers 160. The system 100 provides satellite communication links with bi-directional communication. Through the satellite links, the UEs 110 can receive forward channel data, such as data that one or more servers 160 provided through a network 150, such as the Internet or a core network for telecommunications (e.g., a core network for 5G communications). The satellite links also enables the UEs 110 to send return channel data out through the network 150.

Various types of UEs 110 can be used in system 100, including very small aperture terminals (VSATs). For example, UEs 110 can be mobile devices, such as satellite phones, cellular phones, handsets, or other portable devices that have a capability for sending and receiving signals over the satellite link. UE 110-2 is an example of a terminal, such as a satellite access point, that provides network connectivity to another device 140 and allows one or more other devices to access the network through a satellite link.

In some implementations, a satellite communication link can be provided in addition to other radio access networks. For example, one or more terrestrial base stations 180 can provide cellular network connections at least in some geographic areas. UEs 110 may be configured to be able to use cellular communication links with terrestrial base stations and/or satellite communication links to send and receive data, receive and interact in calls, and so on.

System 100 can employ one or more satellites 120 and satellite gateway 130 in a Radio Access Network (RAN) to provide network connectivity to the UEs 110 through a 3GPP non-terrestrial network (NTN) new radio (NR) (“NTN-NR”) framework and through the 3GPP NTN Internet of Things (IoT) (NTN-IoT) framework. NTN-IoT can also be referred to as NTN NB-IoT to highlight that it has relatively less bandwidth than other communication frameworks, like NTN-NR. While one satellite is shown, it is to be appreciated that the techniques described herein can be applied to a constellation of satellites, such as for example GEO, LEO, and/or MEO satellites. In these embodiments, a UE of UEs 110 may be within the beam of one or more satellites at any time, depending on various factors, such as the size of the constellation and the orbit of the satellites. Generally, the NTN-IoT communication technology is designed for lower power consumption and data rates as compared to NTN-NR communication technology. For instance, NTN-IoT can be used for communication of text messages, and/or small amounts of data. NTN-NR, on the other hand, is directed at providing 5G NR data rates and can be used for voice and video calls, streaming, and other high speed and larger data rates.

In many cases, the current next generation (NG) 5G RAN requires a reasonably high signal noise ratio (SNR) for UEs, such as UEs 110, to maintain a connection. In a satellite access network, however, there are power limitations that can often result in a low SNR for a UE, such as UE 110-1 and UE 110-2. For a UE in NTN-NR, it is possible that at times UEs 110 may not be able to detect the synchronization signals when inside a building, a pocket, a backpack, or is otherwise obstructed from an unobstructed communication path with the satellite. Even when there is still beam coverage (e.g., the UE is within the geographical area of the satellite beam providing connectivity), the UE may not be reachable by the NTN NR network due to additional path loss.

In further detail, handsets and other UEs often use omnidirectional antennas which have much smaller gain than directional antennas. In a Next Generation (NG) NTN communication, the link budget generally closes with very small margin for those handsets or UEs. When a UE is inside a user's pocket or backpack, or inside a building, the additional path loss may be so great that it causes the UE to be totally unreachable by the satellite access network using NTN-NR. This very low signal strength would render the UE unable to receive messages over the NTN connection that was lost. In some cases, the UE may be able to be reachable by a satellite using a NTN-IoT connection even when it is not reachable by a NTN-NR connection.

For example, when a UE is not actively using a network connection, the UE often operates in a Discontinuous Reception (DRX) mode or an extended Discontinuous Reception (eDRX). These modes alternate between sleep periods when the radio is turned off and periodic active modes when the radio is turned on to monitor for paging messages. When the UE is in the NTN coverage area but has very low SNR, when the UE turns on its radio to begin monitoring for data, the UE may not be able to detect the synchronization signals for the connection, e.g., the Synchronization Signal Block (SSB), Primary Synchronization Signal (PSS), and Secondary Synchronization Signal (SSS) of NG NR. The consequence is that if the RAN (e.g., the satellite access network) sends data, the UE will not be able to receive the data.

A lot of effort has been made to adopt the 3GPP NR framework to the satellite application without modifying the physical layer (NR-NTN). 3GPP NR is a framework to support broadband data system (e.g., enhanced mobile broadband (eMBB)). However, there are difficulties with 3GPP NR when using a power limited system (e.g., a satellite), since it will allocate much more bandwidth than the system is operated on failing to close the link.

The following example illustrates what happens when NR is applied to a power limited satellite system. For instance, assume that a satellite (e.g., at a 30 degree elevation angle) illuminates 53 beams where each beam has 20 physical resource blocks (PRBs) (minimum number PRBs specified by NR). In this case, the satellite exhausts its power to “close” the link for each beam. Closing the link may refer to providing the minimum throughput (spectral efficiency ~20%, 1 Hz BW can support 0.2 bps) with a link margin in a clear-sky line-of-sight environment. If something obscures the path to the satellite in excess of the link margin, the link will likely be broken.

Using the example, 53 beams, with each beam having 20 PRBs, correspond to 1,060 PRBs. Some satellites can support ~100 beams, which may correspond to ~2,000 PRBs. Other satellites may not support as many beams. In an attempt to avoid coverage gaps on the earth's surface, a 5% duty cycle hopping of the beam (illuminate a cell every 20 frames for example) can be used. If a 10 dB link margin is specified, the duty cycle becomes 0.5% which may not be practical. Effective bandwidth for the cell can become 18 KHz. While the duty cycle scheme may work for downlink communications (from the satellite to UE), it may not work for uplink communications (from UE to the satellite). For the uplink direction, one way to improve the link margin is to reduce the signal bandwidth.

According to some configurations, communications in a NTN may use a narrow band system (e.g., the bandwidth is same as PRB size (180 Khz)) such as NTN-NB-IoT (which may be referred to herein as “NTN-IoT”), a satellite may serve 2,000 cells (assuming there is no limitation in the number of formed beams). If a 10 dB link margin is specified, a 10% duty cycle can be used. In this example, the effective bandwidth can be 18 KHz. NB-IoT can allow for a single subcarrier uplink transmission, such as 15 KHz bandwidth. This arrangement can improve the uplink link margin by 11 dB, balancing the links.

In some examples, in cases when the traffic demand exceeds the capacity of the NTN-IoT a hybrid system between NTN-IoT and NTN-NR can be used. This hybrid system may provide reliable and robust communication service for basic needs (e.g., SMS) while supporting a sporadic high volume traffic demand.

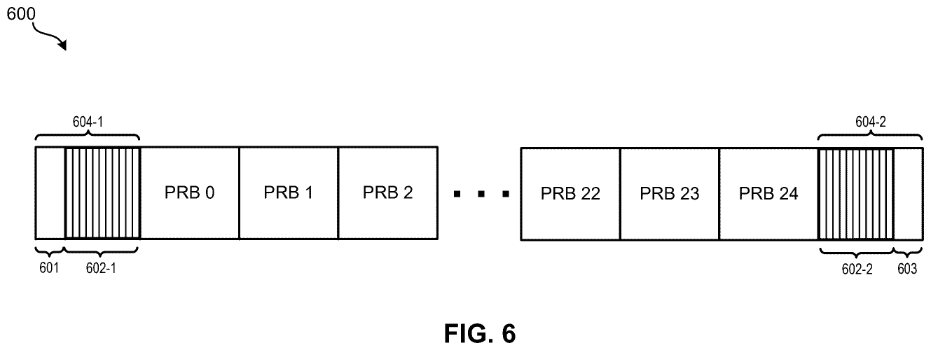

According to some configurations, NB-IoT carriers 602-1 and 602-2 can be placed in a guard band of an NR frequency allocation 600 as illustrated in FIG. 6. In FIG. 6, guard bands 604-1 and 604-2 are present. A guard band may be an intentionally unused frequency band that is placed between adjacent frequency bands in an attempt to minimize interference between communications on the different bands. For example, the low frequency portion of NR frequency allocation 600, frequency range 601, may be a 62.5 kHz margin. At the high frequency end of NR frequency allocation 600, frequency range 603, can serve as a guard band. Frequency range 603 can be a 77.5 kHz margin after the NB-IoT carrier 602-2, which can be sufficient to accommodate a +/−45 kHz doppler frequency shift. Frequency ranges 601 and 603 can serve as guard bands between NB-IoT carriers and adjacent frequency allocations. A margin for adjacent channel leakage ratio (ACLR)/out-of-band (OOB) for downlink and OOB blockage and adjacent channel selectivity (ACS) for uplink can be relatively thin, such as the bandwidth equivalent to ⅓ of a PRB. This technique may provide a robust and reliable communication services for certain usages such as texting and messaging.

Satellite 120 may be configured to communicate using both NTN-NR and NTN-IoT, NTN-NR, or NTN-IoT using different hopping schemes. In some cases, instead of performing beam hopping, a hopping technique hops the PRB (e.g., hop the 180 kHz PRB) used for communication. In the example, satellite power may be spread over 180 kHz PRBs in 1 ms slots. NTN-NR may use periodic hopping with up to 160 ms between System Synchronization Blocks (SSBs). NTN-IoT can be configured to transmit on independent channels and use extended hop duration hopping.

In some configurations, NTN-NR beams can be activated as needed (e.g., the cell(s) when the traffic demands exceed the NB-IoT capacity). This may support simultaneous operation or shared operation. High volume demand can be sporadic and localized via a small number of beams. Turning on a small number of NTN-NR carriers can have limited effect on the satellite power pool if managed.

In another technique to use both NTN-NR and NTN-IoT, a steering technique can be used where a UE can be instructed to switch from NTN-IoT to NTN-NR, or from NTN-NR to NTN-IoT. In some examples, a base station can direct UE 110 to switch. When UE 110 is in idle mode in NB-IoT, this can be done with idle mode re-selection assisted by SIB3-NB (cell re-selection priority) and SIB4-NB (nbr cell info). When the UE 110 is in RRC connected mode, the base station can send a “RRC release with redirect” message to the UE 110 which includes the frequency information for the target RAT. A similar procedure can be used for the other direction. After the UE is moved to the other RAT, the base station can turn off the other beam to save power.

In some examples, UEs 110 can use a combination of NTN-IoT and NTN-NR to deliver SMS and wideband services. UEs 110 can send and receive SMS messages on NTN-IoT carrier. The network signaling can be optimized to deliver messages over NTN-NR or NTN-IoT. UEs 110 can use higher bit rate messaging, voice, and data when connected to NTN-NR. The UE 110 can have information indicative of the transport and make the decision of what services to provide. In some configurations, a network manager 122 can be used to determine when to switch between NTN-NR and NTN-IoT and instruct UE 110 to perform the switching.

The techniques described herein can provide several benefits to system 100. For example, instructing a UE to switch from one communication protocol (e.g., NTN-NR) to another communication protocol (e.g., NTN-IoT) can provide the UE with sufficient bandwidth to perform a desired task. For instance, if the UE is attempting to send a text message and is attached to the NTN-NR communication protocol, the framework selector may instruct the UE to switch to the NTN-IoT communication protocol since the bandwidth of the NTN-NR communication protocol is not needed for a low bandwidth activity, such as sending a text message. Such a switch may also be based on demands within the current NTN. The framework selector may also instruct a UE to switch to a different communication protocol based on current signal conditions to assist in improving signal conditions.

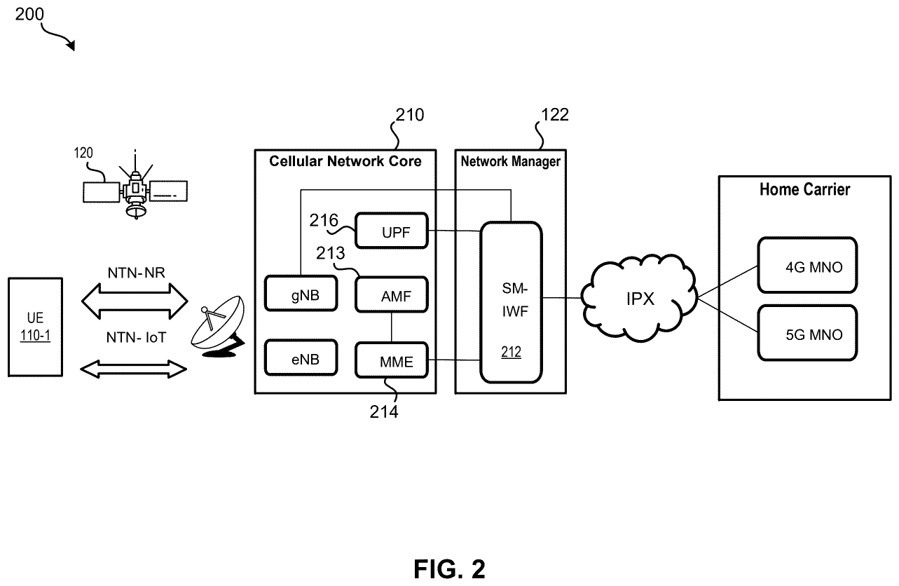

FIG. 2 illustrates satellite 120 communicating with UE 110-1 using both NTN-NR and NTN-IoT. According to some examples, NTN-NR and NTN-IoT can be used in combination to provide short message service (SMS) and instant message (IM) messaging. In some configurations, NTN-IoT is used for robust connectivity for SMS and NTN-NR is used for wideband data (e.g., for SMS and IM or rich communication services (RCS) messaging). According to some examples, NTN-IoT is used as a primary communication method with NTN-NR turned on in response to a determination that the benefits of NTN-NR would be helpful to provide a better user experience.

As illustrated, UE 110-1 is configured to support NTN-NR and NTN-IoT. UE 110-1 can register on NTN-NR for IMS messaging (SMS over IMS) and registers on NTN-IoT for SMS over non-access stratum (NAS). In some configurations, UE 110-1 can select between NTN-NR and NTN-IoT based on coverage or select NTN-IoT for as primary connection, select NTN-NR based on device/user action and reselect NTN-IoT based upon some other condition (e.g., when not needed)

Core 210 can manage 5G connections via NTN-NR and can manage 4G connections via NTN-IoT. AMF 213 and MME 214 communicate over the N26 interface to maintain a single device context. Satellite messaging hub-interworking function (SM-IWF) system 212 (referred to as “SM-IWF 212” for short) can connect to UPF 216 for IMS Messaging over NTN-NR and can connect to AMF 213 for SMS over NAS and possibly location data and can connect to MME 214 for SMS over NAS over NB-IoT.

SM-IWF 212 can act as a proxy information management system (IMS) over IMS connection to the 4G/5G home carrier. Generally, SM-IWF 212 determines a current point of attachment of UE 110 and messaging capabilities (SMS over NAS/Messaging over IMS), proxies MT IMS to SMS over NAS over NB-IoT, proxies MO SMS to IMS over 4G or 5G home carrier and receives a trigger. The home carrier can be a cellular network for 4G and 5G subscribers that supports IMS messaging and can be an interface to a satellite network via IPX.

The following illustrates two different possible techniques for using NTN-NR and NTN-IoT. As a first example, initially, UE loses terrestrial coverage and sees that NTN-NR is available. UE 110-1 can register with NTN-NR on 5G Core via AMF 213. SM-IWF 212 can complete roaming registration including for messaging over IMS and RCS via SM-IWF with the home carrier if necessary. UE originated and UE terminated messages containing text and static images are completed over the NTN-NR carrier. SM-IWF 212 can notify the sender of an inability to deliver additional content.

If UE 110-1 loses NTN-NR coverage, then UE 110-1 can scan for NTN-IoT coverage and attach. UE 110-1 can register for SMS over NAS with the 4G core via MME 214. MME 214 notifies AMF 213 of the reachability via MME 214. UE 110-1 originated SMS are delivered to the home carrier via SM-IWF 212 and UE terminated messages are parsed and SMS component is delivered over NAS to UE 110-1. Any undeliverable components (e.g., not supported by NTN-IoT) can be stored by SM-IWF 212.

When UE 110-1 regains NTN-NR coverage, UE 110-1 can register for NTN-NR service and the network notifies SM-IWF 212 of the reachability of UE 110-1. SM-IWF 212 can deliver any non-delivered outstanding static multi-media components.

As a second example that is optimized for radio frequency (RF) usage, the NTN network is configured to broadcast only NTN-IoT by default. NTN-NR control information (SSB/SIB) may not be transmitted. UE 110-1 may at some point lose terrestrial coverage and can connect with the NTN-IoT carrier. While NTN-NR may be available, UE 110-1 prefers to connect to the NTN-IoT. UE 110-1 registers with NTN-IoT on 4G Core via MME 214. SM-IWF 212 completes roaming registration including for messaging SMS over NAS with the home carrier. UE 110-1 originated and UE terminated SMS messages are transmitted over the NTN-IoT carrier.

As some point, UE 110-1 may need to use NTN-NR services (e.g., for a higher-bandwidth application) and detects coverage. UE 110-1 can initiate NTN-NR registration via control channel messaging to SM-IWF 212 which include measurement data of NTN-IoT signal strength. SM-IWF 212 confirms viability of NTN-NR coverage based on NTN-IoT measurement. SM-IWF 212 can instruct a gNB via O-RAN E2 (RIC) interface to begin NTN-NR transmission in UE 110-1's current cell. SM-IWF 212 replies to UE 110-1 via NTN-IoT to initiate NTN-NR registration.

UE 110-1 registers with NTN-NR carrier and SM-IWF 212 updates registration with a home carrier to support messaging over IMS. The registration may restrict transmission of specific content types, such as allowing static images and voice but restricting transmission of video. UE 110-1 originated and UE 110-1 terminated messages are available over NTN-NR carrier. UE 110-1 utilizes other NTN-NR services (application data) while connected to NTN-NR. The NTN-NR service is ended via timeout, user action, or some other determined condition. SM-IWF 212 can instruct UE 110-1 to reselect the NTN-IoT carrier. SM-IWF 212 instructs gNB to stop NTN-NR transmission via E2 RIC interface if no other users in the cell are active.

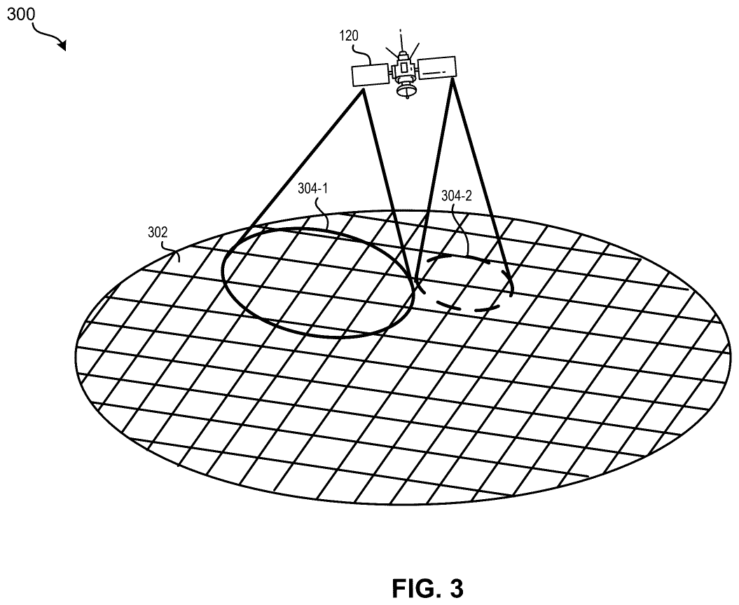

FIG. 3 illustrates an embodiment 300 of satellite cells 302 produced by a satellite 120 using both NTN-NR and NTN-IoT. A satellite cell 302 may be formed using a single beam or multiple beams. For example, multiple beams used to service a satellite cell may use the same frequency. Alternatively, a satellite cell may use one beam for each frequency of a set of multiple different frequencies. For example, beam 304-1 and beam 304-2 may support separate satellite cells. While one satellite is shown, it is to be appreciated that techniques described herein may be applied to multi-satellite constellations, such as LEO and MEO satellites, with overlapping coverage areas.

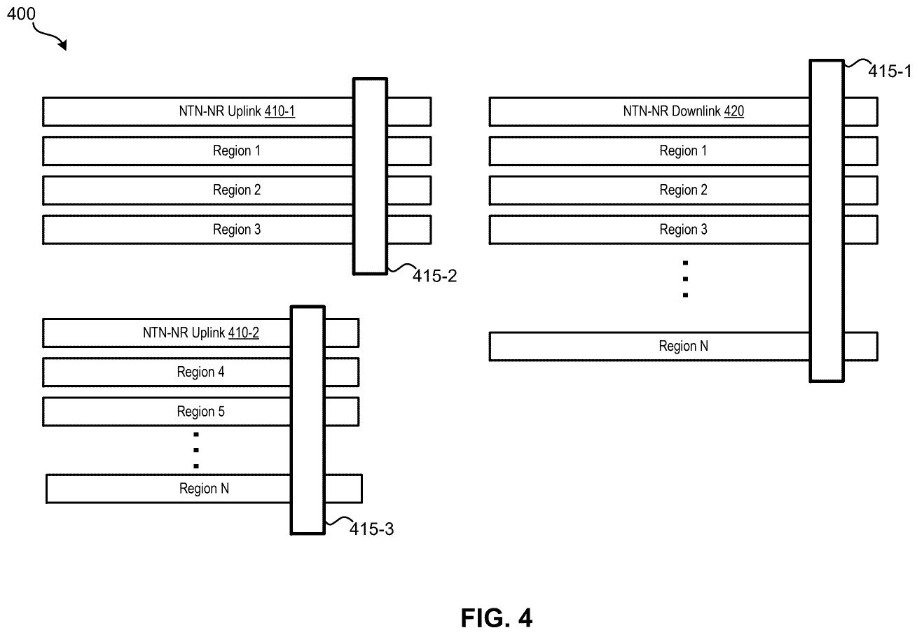

FIG. 4 illustrates a bandwidth plan 400 for uplink 410 and downlink 420. This example diagram is for illustration purposes and other spectrum can be used in other embodiments. As illustrated, NTN-NR downlink 420 uses spectrum 415-1 (e.g., 2195-2200 MHz) for geographic regions 1-N. NTN-NR uplink 410-1 uses spectrum 415-2 (e.g., 2005-2010 MHz) for international telecommunication union (ITU) regions 1-3, and a second spectrum 415-3 (e.g., 2015-2020 MHz) for regions 4-N. which can be NR or IoT. Generally, any available spectrum 415 may be selected. In some examples, NTN-IoT can be in a 5 MHz range adjacent to the NR band.

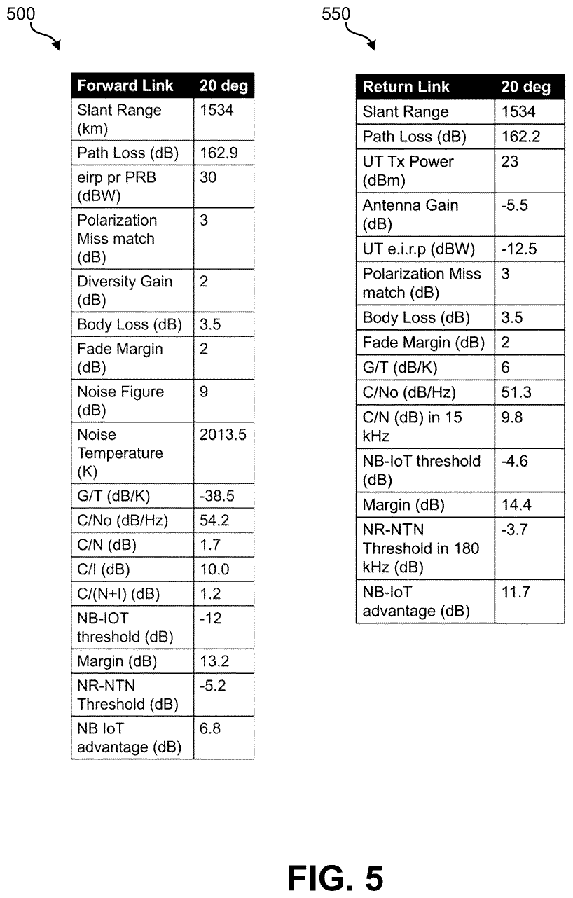

FIG. 5 illustrates an example user link budget for a UE, such as UE 110-1. For the example illustrated by FIG. 5, assume NTN-IoT carrier has the same effective isotropic radiated power (eirp) as a PRB in NTN-NR. For return link 550, assume the transmit power is used to transmit NB-IoT signal in a single 15 kHz. In some examples, both NB-IoT and NR-NTN use the same antenna and T/R module. Estimated thresholds can be used for both NB-IoT and NR-NTN. Referring to links 500 and 550, it appears that NB-IoT offers approximately a 12-13 dB margin. In some examples, additional forward link margin may be obtained with a power boost. This can allow the NB-IoT margin to be increased to 18-19 dB and the advantage over NR about 12 dB. This could be used in limited cells though due to satellite power. For more margin in the return link, an antenna with improved gain can be used.

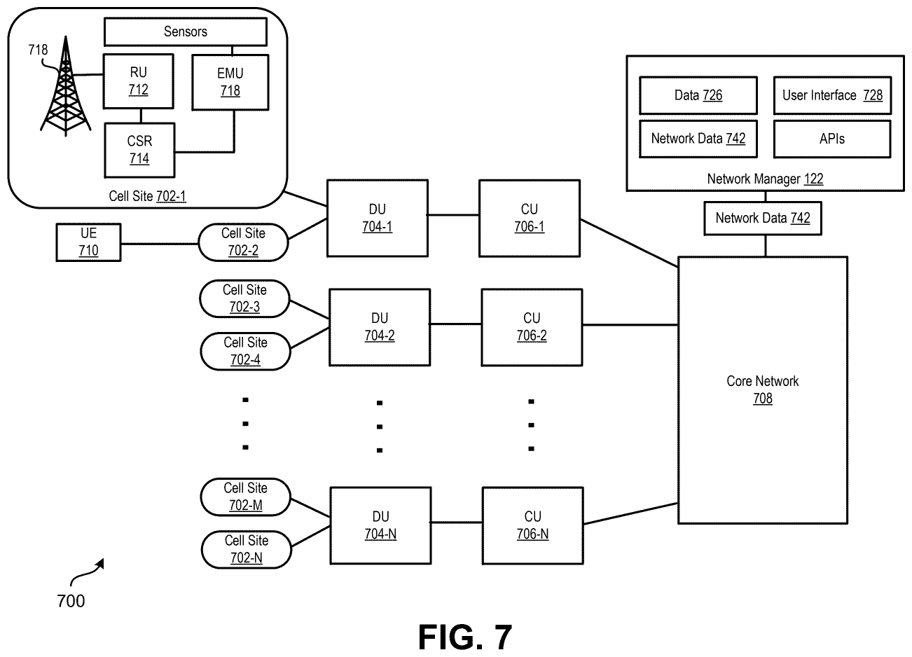

FIG. 7 illustrates system architecture 700 of an O-RAN in accordance with the present disclosure comprises multiple cell sites, such as cell sites 702-1, -2, -3, -4, . . . , -N. As illustrated in this example, within a given cell site, such as 702-1, one or more radio units (RU) are installed in the O-RAN in accordance with the present disclosure. A given one of the RUs, such as RU 712, in a given cell site, such as cell site 702-1, comprises hardware components such as radio frequency (RF) transceivers, antennas configured to transmit and receive RF signals from/to end UE, such as smartphones.

As illustrated, a cell site 702, such as cell site 702-1 includes a CSR 714 coupled to EMU 718 and RU 712. The EMU 718 is coupled to one or more sensors. In various implementations, EMUs and/or RUs in different cell sites 702 in the example system architecture 700 can be provided by different hardware vendors. While EMU 718, sensors, and CSR 714 are only illustrated in cell site 702-1, an EMU 718, sensors, and CSR 714 can be included in all, or a portion, of the cell sites 702-1 through 702-N. It is contemplated that in some examples, the cell sites in the example system architecture 700 are heterogenous in terms of hardware they are implemented in.

Also shown in FIG. 7 are distributed units (DUs) 704-1, 704-2 . . . and 704-N. A given one of the DUs, such as 704-1 in this example, is configured to facilitate real-time baseband processing function. Various protocols can be configured into the given DU, such as RLC, PDCP MAC and/or any other lower-level protocols. In various implementations, the given DU is configured to communicate with at least one RU in a cell site. For example, as shown in this example, the DU 704-1 is configured to communicate with the RUs in cell sites 702-1 and 702-2, the DU 704-1 is configured to communicate with the RUs in cell sites 702-3 and 702-4, and DU 704-N is configured to communicate with the RUs in cell sites in 702-N. It should be understood that the communications illustrated between the DUs and the cell sites in FIG. 7 are merely illustrative and thus should not be understood as limiting a scope of the O-RAN in accordance with the present disclosure. That is, the O-RAN in accordance with the present disclosure is not limited to one DU connected only to two cell sites as illustrated in FIG. 7. One skilled in the art understands that the O-RAN in accordance with the present disclosure can comprise a DU configured to however many cell sites.

A given communication link between a given DU and given RU in a cell site is typically referred to as a fronthaul—for example, the links between cell sites 702-1/-2 and DU 704-1. In that example, the DU 704-1 is configured to consolidate and process inbound traffic from RUs in the cell sites 702-1/-2, distributes traffic to the RUs in the cell sites 702-1/-2. In implementations, the DUs can be located near the cell sites they have communication with or centralized in a local data center provided by a vendor. In some implementations, various functionalities in the DUs can be implemented using software.

Still shown in FIG. 7 are centralized units (CUs), such as CU 706-1, 706-2, and 706-N. A given one of the CUs is configured to handle higher layers of communication protocols as compared to a DU. For example, less time-sensitive packet processing, such as SDAP, RRC or PDCP, may be implemented in the given CU. It should be understood that functionality split between CU and DU is not intended to be specifically limited in the present disclosure. It is understood that such a split can be a design choice for a particular O-RAN. That is, the present disclosure should not be understood as being limited to a specific version or specific versions of O-RAN, where splits between CU and DU are specifically defined. For example, a DU may be separate from the RU and a CU, the DU can be co-located with the CU, or the DU can be bundled with the RU. The DU can also run standalone and/or be within a pool of DUs. Collectively, RUs, DUs, and a CU can create a gNodeB, which serves as a radio access network (RAN) of example system architecture 700.

In implementations, CUs in an O-RAN in accordance with the present disclosure can be implemented using software. In some examples, the given CU may be located in a data center provided by a third-party vendor. In some examples, one or more of the given CU can be located in the data center. The individual links between a CU and DU is typically referred to as a mid-haul link, for example the link between 704-1 and 706-1 shown in this example.

FIG. 7 also shows a core network 708. The core network 708 is configured to enable end users to access services such as phone calls, internet, etc. In various examples, the core network 708 is configured to handle operations such as subscriber location, profile, authentication, and/or any other operations. In those examples, such operations can facilitate the end users to employ communication technologies (such as 5G) through the example system architecture 700. In some examples, the services and/or operations provided by the core network 708 are implemented using software. Although only one core network 708 is shown in FIG. 7, this is not intended to be limiting. It should be understood the example system architecture 700 is not intended to be limited to 5G. It is understood examples provided herein can be applied to other types of cell sites when appropriate, such as LTE, 3G, 5G, WIFI or any other types of networks.

In various other examples, more than one core network 708 can be included in the O-RAN in accordance with the present disclosure. Links between a CU and the core network 708 are typically referred to as backhaul links, for example, the link between CU 706-1 and core network 708 shown in this example. The fronthaul links, mid-haul links, and backhaul links shown in FIG. 7 may be collectively referred to as a transport layer for the example system architecture 700. In various examples, the transport layer is configured to handle end-to-end communication over the O-RAN in accordance with the present disclosure.

As illustrated, a network manager 122 is coupled to the core network 708. The network manager 122 is configured to interact with components deployed within the cellular network, deployed at cell sites 702, and deployed within a NTN network, such as illustrated in FIG. 7. As briefly discussed above, the network manager 122 can be configured to perform operations relating to using NTN-NR and NTN-IoT as described herein. The network manager 122 also interacts with different components within the core network 708 and at other locations within the cellular network. For instance, the network manager 122 may communicate with different brands of components (e.g., RUs 712, EMUs 718, . . . ) deployed at cell sites 702 and provided by different suppliers/vendors using the same application/tool/UI. For instance, one or more of the cell sites 702 may have RUs 712, EMUs 718 from different vendors.

In some examples, the network manager 122 connects to the components within a cell site 702 using a CSR 714. According to some configurations, the EMU 718 is connected to sensors. The network manager 122 can also obtain information related to the current performance of one or more components of the cellular network. For example, the network manager 122 may obtain information about the current RF characteristics at a cell site 702, determine if one or more components deployed within the cell site is not operating as intended (e.g., a component is offline, operating at reduced performance, ...), and the like.

In some examples, the network manager 122 can integrate with devices/components such as but not limited to different brands of RUs, DUs, CUs, EMUs 718, element management systems (EMSs), inventory management tools, network monitoring tools, validation/testing tools, data sharing services, and the like. According to some examples, application programming interfaces (APIs) can be used to interact with functionality provided by different components. The APIs may be provided by a hardware vendor, and/or be custom APIs developed to interact with one or more components.

In some examples, a user uses user interface (UI) 728 to view data, connect and interact with different components within the cellular network, cause one or more actions to be performed, and the like. The UI 728 may also be used to specify one or more operations to be performed at one or more identified cell sites 702 and/or at some other location within a network. In some configurations, the network manager 122 determines the IP addresses of the components that are involved in the one or more operations, establishes a network connection with the identified components using the determined IP addresses, and then causes the one or more operations to be performed. In some configurations, the network manager 122 can create payloads based on the component being interacted with. In some examples, when a configuration change is made to a component, an element management system (EMS) (not shown) is automatically updated to reflect the change.

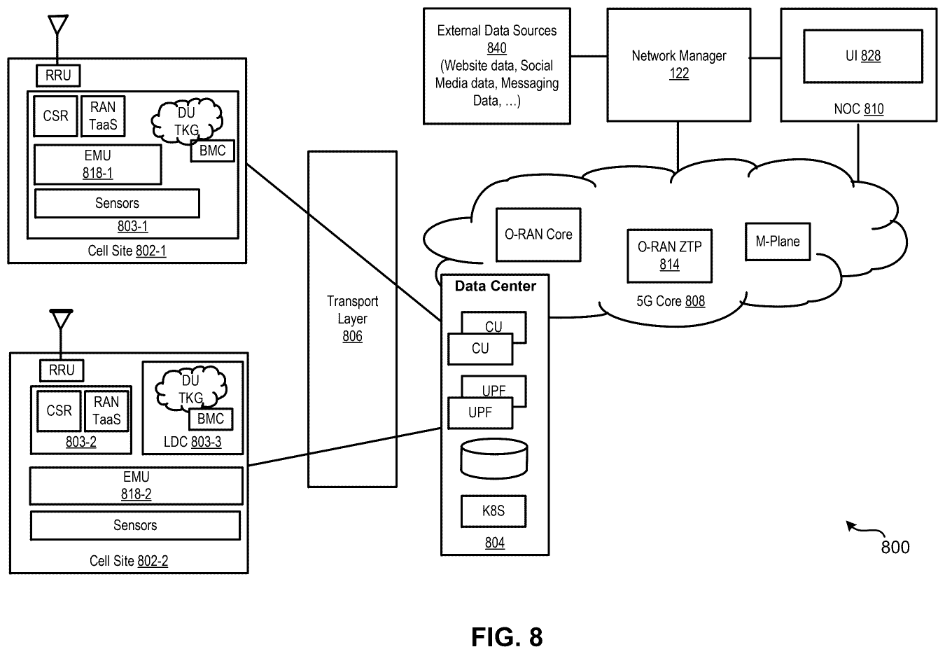

With an example system architecture 700 of O-RAN in accordance with the present disclosure having been generally described and illustrated, attention is now directed to FIG. 8, where an example system architecture 800 of a 5G O-RAN implement in a cloud is generally illustrated.

As shown FIG. 8, the example system architecture 800 of a 5G O-RAN comprises a cell site 802-1, a cell site 802-2, and/or any other cell site(s). As shown, each of the cell site 802-1, and 802-2, in this example, includes a remote radio unit (RRU). In this example, one or more computing devices, located outside the cell site 802-2, are configured to implement a cell site router (CSR), a DU, a baseband management controller (BMC), a RAN, a RAN TaaS (test as a service), and/or any other components. In some examples, the computing device includes a processor configured to implement various components mentioned above. In some examples, the computing device(s) includes an operating system such as a Linux system to implement these components. In that example, the computing device(s) is located in a cabinet within a proximity of the cell site 802-1, and cell site 802-1 is referred to as a “lite site”.

The cell site 802-2 includes a computing device 803-2 and another computing device (local data center) 803-3. In this example, the computing devices 803-2 and 803-3 are located within the cell site 802-2. In some examples, the computing devices 803-2 and 803-3 are located in a cabinet within the cell site 802-2. In that example, the cell site 802-2 is referred to as a “dark site”.

As shown, in this example, the computing device 803-2 is configured to implement the CSR, RAN, and/or any other components, while the computing device 803-3 is configured to implement the DU (for example, hosting Tanzu Kubernetes Grid (TKG)), BMC, and/or any other components. This is to show cell sites in a 5G O-RAN in accordance with the present disclosure can have computing devices located within the cell sites and configured to implement various components whose functionalities attributed to the DU, CSR or RAN. That is, the 5G O-RAN in accordance with the present disclosure is not intended to be limited such that DU and CSR/RAN are implemented on different computing devices, and/or outside the cell site. In some examples, the RAN for a specific cell site such as 802-1 or 802-2 can include tests designed to components and functionalities within the specific cell site, functionalities with another cell site (e.g., adjacency testing), and/or end-to-end testing.

In various examples, the RAN shown in this example is implemented using software and is configured to test and ensure one or more O-RAN components (e.g., the RRU or CSR, in the cell sites are performing in compliance with O-RAN standards). Various tests or test suites can be configured into a RAN to cause target components in the cell sites to be run under preset test conditions. A goal of such a test or test suite in the RAN is to verify that individual components in the cell sites can handle expected traffic and functionality. In some examples, tests in the RAN are run continuously on a preset or configured frequency to ensure the above-mentioned types of testing of the specific cell sites are in compliance with the O-RAN standards continuously.

As shown FIG. 8, the cell sites 802-1 and 802-2 are connected, via the transport layer 806, to a data center 804 configured to host one or more CUs, and one or more UPFs (user plane functions) implementing at least one user plane layer, and/or any other components. In some examples, the data center 804 is referred to as a breakout edge data center (BEDC). In general, the data center 804 is configured to accommodate the distributed nature of various functions in the example system architecture 800 of a 5G O-RAN. In that example, the BEDC hosts various 5G network functions (NFs) that have low latency requirement. In that example, the BEDC provides internet peering for general 5G service and enterprise customer-specific private network service.

In some examples, a storage can be configured to store various (Cloud-native Network Functions) CNFs and artifacts for facilitating implementations of the DUs and CUs in the example system architecture 800 of the 5G O-RAN. Examples of the storage can include Amazon S3, GitHub, Harbor and/or any other storage services.

In some examples, such as shown in FIG. 8, the data center 804 can include one or more Kubernetes (also known as K8S) configured to facilitate automation of deployment, scaling, and management of various software/applications deployed within the data center 804 and/or within one or more cell sites operatively communicating with the data center 804 through the transport layer 806. 5G Core 808 can be implemented such that it is physically distributed across data centers or located at a central national data center (NDC) and/or regional data center (RDC). In this example, 5G core 808 performs various core functions of the 5G network. In implementations, 5G core 808 can include an O-RAN core implementing various 5G services and/or functions such as: network resource management components; policy management components; subscriber management components; packet control components; and/or any other 5G functions or services. Individual components may communicate on a bus, thus allowing various components of 5G core 808 to communicate with each other directly. Implementations 5G core 808 can involve additional other components.

Network resource management components can include: Network Repository Function (NRF) and Network Slice Selection Function (NSSF). NRF can allow 5G network functions (NFs) to register and discover each other via a standards-based application programming interface (API). NSSF can be used by AMF to assist with the selection of a network slice that will serve a particular UE.

Policy management components can include: Charging Function (CHF) and Policy Control Function (PCF). CHF allows charging services to be offered to authorized network functions. A converged online and offline charging can be supported. PCF allows for policy control functions and the related 5G signaling interfaces to be supported.

Subscriber management components can include: Unified Data Management (UDM) and Authentication Server Function (AUSF). UDM can allow for generation of authentication vectors, user identification handling, NF registration management, and retrieval of UE individual subscription data for slice selection. AUSF performs authentication with UE.

Packet control components can include: Access and Mobility Management Function (AMF) and Session Management Function (SMF). AMF can receive connection and session related information from UE and is responsible for handling connection and mobility management tasks. SMF is responsible for interacting with the decoupled data plane, creating updating and removing Protocol Data Unit (PDU) sessions, and managing session context with the User Plane Function (UPF).

In one O-RAN example, DUs, CUs, 5G core 808 and/or any other components in that O-RAN, is implemented virtually as software being executed by general-purpose computing equipment, such as those in one or more data centers. Therefore, depending on needs, the functionality of a DU, CU, and/or 5G 808 core may be implemented locally to each other and/or specific functions of any given component can be performed by physically separated server systems (e.g., at different server farms). For example, some functions of a CU may be located at a same server facility as where the DU is executed, while other functions are executed at a separate server system. In some examples, DUs may be partially or fully added to cloud-based cellular network components. Such cloud-based cellular network components may be executed as specialized software executed by underlying general-purpose computer servers. Cloud-based cellular network components may be executed on a third-party cloud-based computing platform. For instance, a separate entity that provides a cloud-based computing platform may have the ability to devote additional hardware resources to cloud-based cellular network components or implement additional instances of such components when requested.

In implementations, Kubernetes (K8S), or some other container orchestration platform, can be used to create and destroy the logical DU, CU, 5G core units and subunits as needed for the O-RAN to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU is no longer needed, Kubernetes can allow for removal of the logical DU. Kubernetes can also be used to control the flow of data (e.g., messages) and inject a flow of data to various components. This arrangement can allow for the modification of nominal behavior of various layers.

In implementations, the deployment, scaling, and management of such virtualized components can be managed by an orchestrator (such as Kubernetes) in the 5G core 808. The orchestrator can trigger various software processes executed by underlying computer hardware. In implementations, the one or more management functions (managing the 5G core 808, and/or the example system architecture 800 in general) can be implemented in the 5G core 808, for example through a M-Plane. The M-Plane can be configured to facilitate monitoring of O-RAN and determining the amount and location at which cellular network functions should be deployed to meet or attempt to meet service level agreements (SLAs) across slices of the cellular network.

In various implementations, the orchestrator can allow for the instantiation of new cloud-based components of the example system architecture 800 of the 5G O-RAN. As an example, to upgrade one of EMUs 818, the orchestrator can perform a pipeline of calling the EMU upgrade code from a software repository incorporated as part of, or separate from, cellular network; pulling corresponding configuration files (e.g., helm charts); creating Kubernetes nodes/pods; configuring the EMU; and activating other support functions (e.g., connections to test tools).

In some implementations, a network slice functions as a virtual network operating on example system architecture 800 of the 5G O-RAN. In those implementations, example system architecture 800 of the 5G O-RAN is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular network slices may only be reserved in particular geographic regions. For instance, a first set of network slices may be present at a given RU and a given DU, a second set of network slices, which may only partially overlap or may be wholly different than the first set, may be reserved at the given RU and the given DU.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

In some examples, the 5G core 808 implements a O-RAN ZTP (zero touch provisioning) layer. In general, in those examples, the O-RAN ZTP layer is configured to facilitate automation of the deployment workflow within the example system architecture 800 of the 5G O-RAN. ZTP is commonly known as automated deployment of software (new or updates) to various components in a system with as little human intervention as possible. In the context of example system architecture 800 of the 5G O-RAN, ZTP means automated deployment of software (new or updates) to hardware and/or software components such as RUs, CSRs, DUs, CUs, and various modules in the 5G core 808 with little human intervention.

For example, without an engineer having to be present at a specific cell site such as 802-1 or 802-2, O-RAN ZTP can facilitate automatic updates of a component with the latest software, such as updates of an RU with the latest RU software, updates of a DU with the latest DU software and/or changing from one vendor's RU/DU to another vendor's RU/DU. It should be understood the O-RAN ZTP layer is referred to a set of components that work together to facilitate automatic deployment of software in the example system architecture 800 of the 5G O-RAN with little human intervention. Thus, although, the O-RAN ZTP layer is shown being implemented in the 5G core 808 in FIG. 8, it is merely illustrative. That is, the O-RAN ZTP in accordance with the present disclosure is not intended to be limited to components implemented a core of the O-RAN in accordance with the present disclosure. In some other examples, one or more components of the O-RAN ZTP can be implemented in, for example, CUs or DUs in the O-RAN in accordance with the present disclosure. For instance, as will be described below, adaptors configured to communicate with devices or components of different vendors for ZTP operations can be implemented in CUs or DUs.

Also shown in FIG. 8 is a NOC 810 (Network Operation Center). In some examples, the NOC 810 is implemented on a general-purpose computing device. In those examples, one or more interfaces are implemented in the NOC 810.

According to some configurations, the UI 828 can be used to view data obtained from one or more cell sites, add components/sensors/devices to a cell site, view health data associated with the cell site, and the like. According to some configurations, network manager 122 can be used to manage components installed at a cell site. In some examples, the network manager 122 is configured to provide status checks for components associated with cell sites.

The NOC 810 can also be used by an operator to set a schedule to update one or more network services in the 5G core 808. As another illustration, an interface is provided in the NOC 810 to enable the operator to push software to a specific component in a cell site (such as 802-1 or 802-2) or in a data center (such as 804) to configure or update the component. As another example, an interface is provided in the NOC 810 to enable an operator to provision one or more C-RAN components. The NOC 810 can also be used to configure alarms for one or more detected cell site conditions.

One or more requests can be generated by the NOC 810 to instigate the deployment of the software as scheduled or intended by the operator. The request(s) can be received by the O-RAN ZTP layer 814, which in turn can generate one or more commands to deploy the software to the component. Although one NOC 810 is shown in this example, this is not intended to be limiting. More than one NOCs are typically deployed in the example system architecture 800 of the 5G O-RAN. In some implementations, a given NOC may be provided by a vendor to the 5G O-RAN. For instance, the vendor may be a software develop that provides components or services to the example system architecture 800 of a 5G O-RAN. In that instance, the given NOC is a computing device or system on a premise of the software developer.

Components such as EMUs, RUs, DUs, CUs, O-RAN ZTP layer, interfaces in the NOC 810, and/or any other components in the 5G core 808 may include various software components communicating with each other, handling large volumes of data traffic, and be able to properly respond to changes in the network. In order to ensure not only the functionality and interoperability of such components, but also the ability to respond to changing network conditions and the ability to meet or perform above vendor specifications, significant testing must be performed.

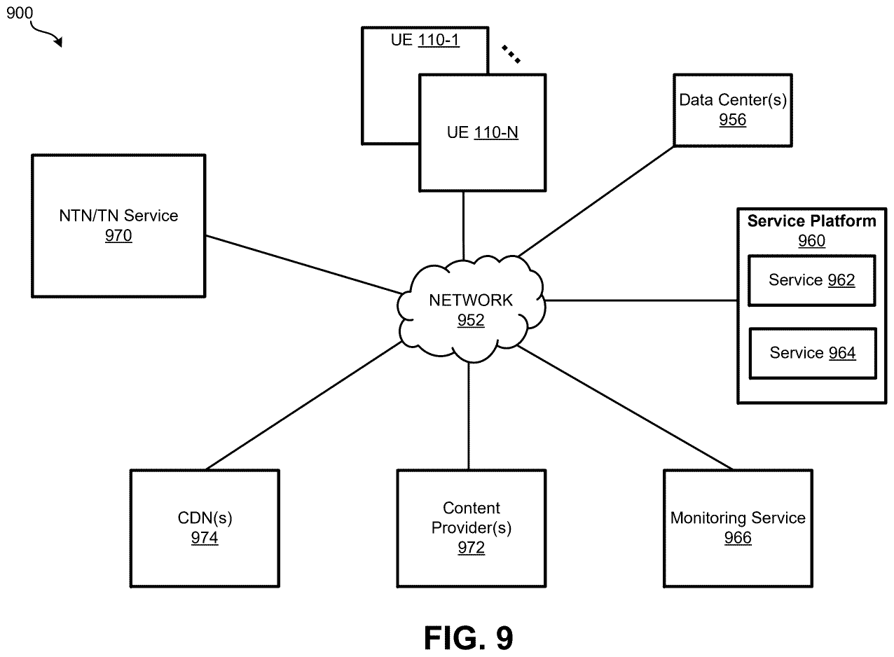

FIG. 9 illustrates a communications system 900 that uses NTN-NR and NTN-IoT, according to various examples. The system 900 includes one or more devices, such as UE 110-1-110-N. In some examples, each of the devices includes a computing system (not shown). The computing system contains processing resources such as computing resources, memory device, and data storage resources. The UEs 110 are communicatively interconnected with each other through network 952. Also, UEs 110 may include, or be part of, various types of devices including, but not limited to: smartphones, tablets, notebook computers, mobile devices, sensors, vehicles, autonomous vehicles, machinery, appliances, smart speakers, digital assistants, security cameras, monitoring devices, home electronics, media players, receiving devices, set-top boxes, other computing devices and IoT devices, etc.

Network 952 may also provide connectivity to other networks and geographically separated devices, such as service platform 960, monitoring service 966, and devices in data center(s) 956 (e.g., local data centers, regional data centers, national data centers), content provider(s) 972, content delivery network(s) 974, and NTN/TN service 970. In some examples, network 952 includes the main mobile core network which provides subscriber profile information, subscriber location, authentication of services, and the necessary switching functions for voice and data sessions, including circuit-switched services, packet-switched services. Network 952 may also provide cloud-aligned, service-based architecture (SBA) that spans across various functions and interactions including authentication, security, session management, and aggregation of traffic from end devices.

Network 952 may also include equipment and provide functionality to provide Internet connectivity to the user equipment 110, and connectivity to other devices and systems, such as service platform 960, monitoring service 966, and devices in data center(s) 956, content provider(s) 972, content delivery network(s) 974, and the cellular network issue identification service 970, using other additional or integrated networks. For example, network 952 may include one or more computer networks, one or more wired or wireless networks, satellite transmission media, one or more cellular networks, the Internet or some combination thereof, including routers, switches, gateways and other network equipment providing such connectivity. The network 952 may include a publicly accessible network of linked networks, possibly operated by various distinct parties, such as the Internet. In some examples, the network is a 5G-based network, such as illustrated in FIG. 7 and FIG. 8.

In some examples, the NTN/TN service 970 is configured to perform operations relating to using NTN-NR and NTN-IoT as described herein.

The monitoring service 966 may include various monitoring tools for collecting real-time network data. For example, a NetFlow analyzer may be used to monitor and analyze network traffic flows in real-time and provide visibility into network bandwidth usage, application performance, and security threats by analyzing flow data generated by the network devices. Simple Network Management Protocol (SNMP) may be used to collect and analyze performance data from network devices, monitor current health status of each device, traffic utilization, and other metrics. Bandwidth monitoring tools may be used to track network bandwidth usage in real-time, monitor traffic patterns, identify bandwidth-intensive applications, and detect abnormal usage patterns that may indicate network congestion or security threats. QoS analyzer may be used to assess network performance based on predetermined service level agreements (SLAs) or QoS parameters and determine if the real-time network performance is in compliance with QoS standards. APM tool may be used to collect data including metrics such as response time, throughput, error rates, CPU and memory utilization, database query performance, latency, and more, during execution of one or more applications.

Multi-Access Edge Computing (MEC) is an element of 5G architecture that can bring the applications from centralized data centers to the network edge, and therefore closer to end users and their devices. This essentially creates a shortcut in content delivery between the user and host, and the long network path that once separated them. Characteristics of the MEC include the low latency, last mile telecommunication, high bandwidth, high speed, and real time access to RAN information that distinguish 5G architecture from its predecessors. In some examples, this low latency, high bandwidth and real time access to an increasing number of small and macro 5G cells equipped on the 5G devices, is utilized in a unique way to tap into the available processing resources at these computing nodes.

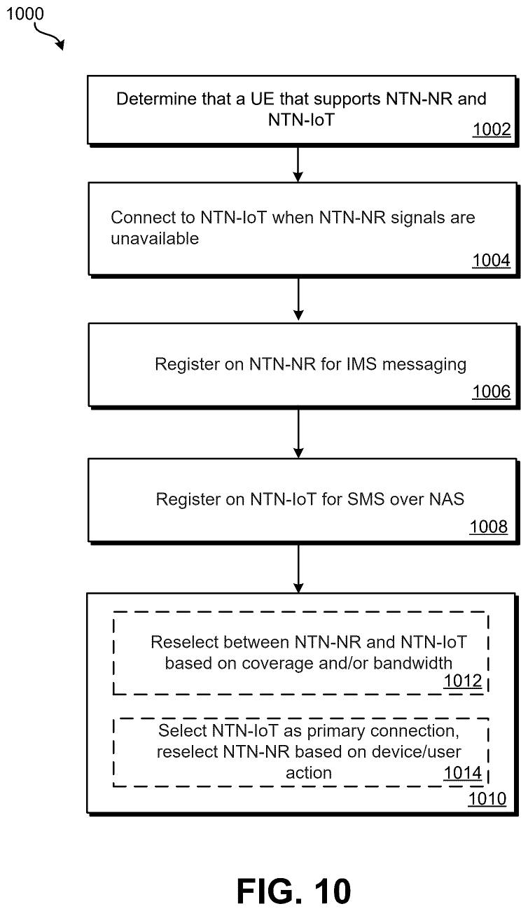

In accordance with the systems and arrangements detailed in relation to FIGS. 1-9, various methods can be performed. FIG. 10 illustrates an embodiment of method 1000 for hybrid communications using NTN-NR and NTN-IoT. Method 1000 may be implemented by one or more components included in the systems described herein. In some configurations, method 1000 is implemented using network manager 122. Depending on the embodiment, method 1000 may include additional, fewer, or alternative steps performed in various orders or in parallel.

At block 1002, a determination is made that a UE, such as UE 110-1, supports both NTN-NR and NTN-IoT. At block 1004, the UE connects to NTN-IoT when NTN-NR signals are unavailable. For example, the UE may perform a scan to detect NTN-IoT or NTN-NR signals. If NTN-NR is available, the UE may establish a connection via the NTN-NR carrier only or via both NTN-NR and NTN-IoT carriers.

At block 1006, the UE can register on NTN-NR for IMS messaging (SMS over IMS). At block 1008, the UE can also register on NTN-IoT for SMS over NAS.

At block 1010, the UE may change between NTN-NR and NTN-IoT based on coverage or bandwidth needs as illustrated by element 1012, or select NTN-IoT as primary connection, and then reselect to NTN-NR based on device/user action as illustrated by element 1014. In some embodiments, the gateway or satellite may instruct the UE to switch between the NTN-NR and NTN-IoT services. In other embodiments, the UE itself makes the selection.

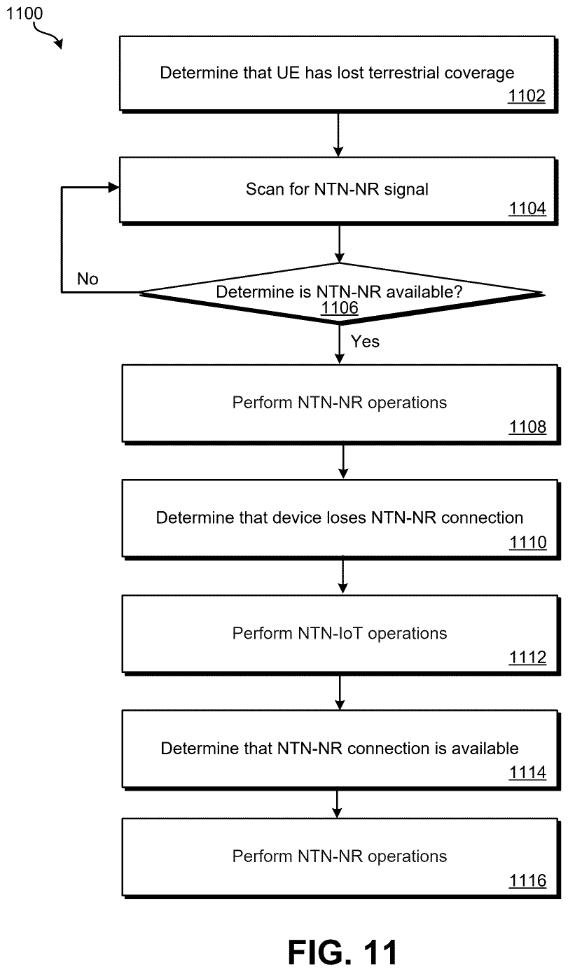

FIG. 11 illustrates an embodiment of a method 1100 for switching between NTN-NR and NTN-IoT. The method 1100 may be implemented by one or more components included in the systems described herein. In some configurations, the method 1100 is implemented by network manager 122. Depending on the example, the method 1100 may include additional, fewer, or alternative steps performed in various orders or in parallel.

At block 1102, a determination is made that indicates the UE 110 has lost terrestrial coverage by no longer being able to communicate with a terrestrial cellular network. At block 1104, the UE 110 scans for an NTN-NR signal in response to block 1102.

At block 1106, a determination is made as to whether communication with an NTN-NR carrier is available. When the NTN-NR carrier is available, method 1100 can advance to block 1108. When NTN-NR is not available, method 1100 can return to block 1104 and continue occasionally or periodically scanning for the NTN-NR carrier and, possibly, a TN cellular network.

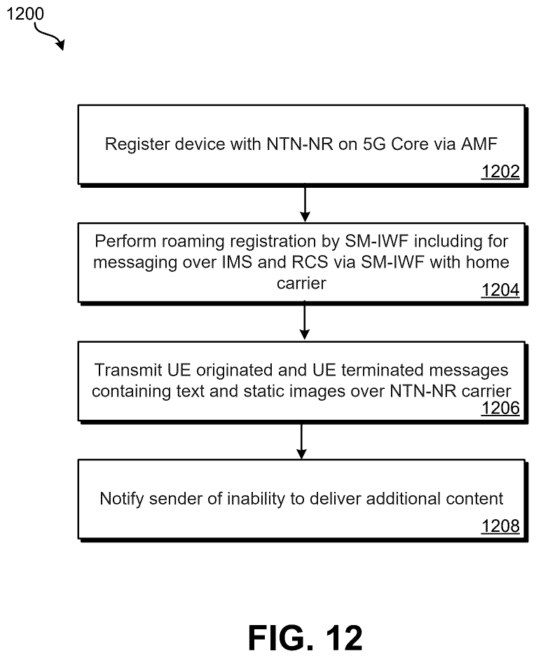

At block 1108, NTN-NR operations can be performed such as detailed in relation to FIG. 12 and method 1200. At block 1110, a determination is made that the UE has lost the NTN-NR connection or the NTN-NR connection does not have a sufficient signal to exchange data.

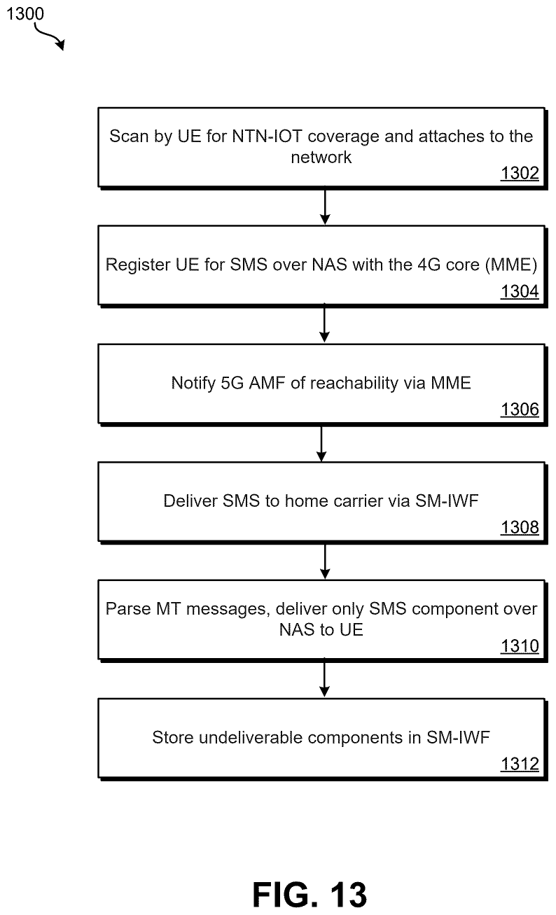

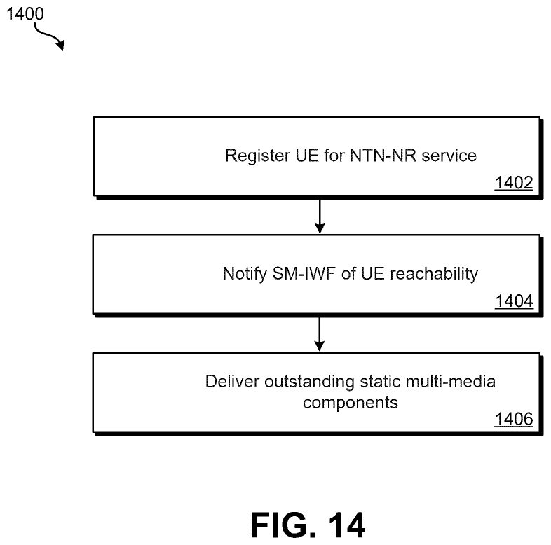

At block 1112, NTN-IoT operations can be performed, such as detailed in relation to FIG. 13 and method 1300. At block 1114, a determination is made that the NTN-NR connection has become available. At block 1116, NTN-NR operations are performed such as in relation to FIG. 14 and method 1400.

FIG. 12 illustrates an embodiment of method 1200 for performing NTN-NR operations. Method 1200 may be implemented by one or more components included in the systems described herein. In some configurations, method 1200 is implemented by network manager 122. Depending on the example, method 1200 may include additional, fewer, or alternative steps performed in various orders or in parallel.

At block 1202, a UE, such as UE 110-1, registers with NTN-NR on 5G Core via the AMF. At block 1204, the SM-IWF 212 completes roaming registration including for messaging over IMS and RCS via SM-IWF with home carrier. At block 1206, UE originated and/or UE terminated messages containing text and static images can be completed over the NTN-NR carrier. At block 1208, if content other than text and static images was included such as video, SM-IWF 212 can notify the sender of an inability to deliver such additional content.

FIG. 13 is a flow diagram illustrating an example method 1300 for performing NTN-IoT operations, according to various examples. The method 1300 may be implemented by one or more components included in the systems described herein. In some configurations, the method 1300 is implemented by network manager 122. Depending on the example, the method 1300 may include additional, fewer, or alternative steps performed in various orders or in parallel.

At block 1302, the UE can scan for NTN-IoT coverage and attach to the network. At block 1304, the UE registers for SMS over NAS with the 4G core via the MME. At block 1306, 4G MME can notify the 5G AMF of reachability via MME. At block 1308, UE originated SMS are delivered to home carrier via SM-IWF. At block 1310, UE terminated messages are parsed, and only the SMS component is delivered over NAS to the UE. As such, any video or still images are removed as undeliverable. At block 1312, any undeliverable components are stored in SM-IWF, possibly for future delivery when the UE is back in range of an NTN-NR carrier or TN.

FIG. 14 is a flow diagram illustrating an example method 1400 for performing NTN-NR operations, according to various examples. The method 1400 may be implemented by one or more components included in the systems described herein. In some configurations, the method 1400 is implemented by network manager 122. Depending on the example, the method 1400 may include additional, fewer, or alternative steps performed in various orders or in parallel.

At block 1402, the UE can register for NTN-NR service. At block 1404, the NTN network notifies SM-IWF 212 of the UE's reachability. At block 1406, SM-IWF 212 delivers outstanding static multi-media components such as from block 1312.

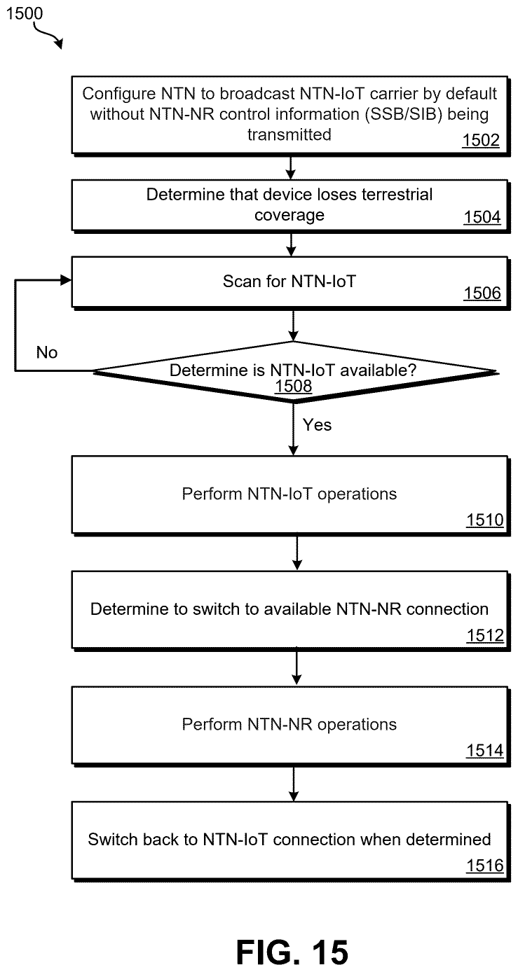

FIG. 15 illustrates an embodiment of method 1500 for using NTN-IoT by default. The method 1500 may be implemented by one or more components included in the systems described herein. In some configurations, the method 1500 is implemented by network manager 122. Depending on the example, the method 1500 may include additional, fewer, or alternative steps performed in various orders or in parallel.

At block 1502, the NTN network is configured to broadcast a NTN-IoT carrier by default. NTN-NR control information (SSB/SIB) may not be transmitted.

At block 1504, a determination is made that indicates the UE has lost terrestrial coverage. This determination can be made at the UE. At block 1506, the UE scans for an NTN-NR signal. At block 1508, a determination is made as to whether NTN-IoT is available. When NTN-IoT is available, method 1500 advances to block 1510. When NTN-IoT is not available, method 1500 returns to block 1506.

At block 1510, NTN-IoT operations are performed. In some examples, the UE registers with NTN-IoT on 4G Core via the MME. The SM-IWF 212 can complete roaming registration including for messaging SMS over NAS with the home carrier. As a result, the UE originated and UE terminated SMS messages are sent over the NTN-IoT carrier.

At block 1512, a determination is made to switch to a NTN-NR connection in response to the NTN-NR carrier coming available. At block 1514, NTN-NR operations can then be performed. In some examples, the UE initiates (e.g., at end user request) NTN-NR registration via control channel messaging to SM-IWF 212 which include measurement data of NTN-IoT signal strength. The SM-IWF 212 confirms viability of NTN-NR coverage based on NTN-IoT measurement. The SM-IWF 212 instructs gNB via O-RAN E2 (RIC) interface to begin NTN-NR transmission in the UE's current cell. The SM-IWF 212 replies to the UE of NB-IoT to initiate NTN-NR registration. The UE can then register with NTN-NR carrier. The SM-IWF 212 updates registration with home carrier to support messaging over IMS. In some examples, the registration may restrict content types (i.e. static images and voice allowed, no video). Now, the UE originated, and UE terminated messages are available over the NTN-NR carrier. The user of the UE can also utilize other NTN-NR services (application data) while connected to NTN-NR. The NTN-NR service may be completed via timeout or user action.

At block 1516, the UE switches back to NTN-IoT when determined. In some examples, the SM-IWF 212 instructs device to reselect to NTN-IoT carrier and the SM-IWF 212 instructs gNB to stop NTN-NR transmission via E2 RIC interface if no other users in the cell are active.

As described above, many communication systems perform paging to notify wireless communication devices of an incoming call or message. When a UE is not transmitting or receiving data, the UE generally enters an idle mode to conserve power. Paging enables the communication system to direct an incoming call or message to a UE that is in idle mode. However, if the signal-to-noise ratio is very low for the UE, the UE may not successfully receive a paging signal and thus may not receive an incoming call or message.

In some examples, a communication system may be configured to transmit a paging message over one or more different communication methods, such as NTN-IoT, NTN-NR or Voice over LTE (“VoLTE”) if the UE fails to receive the paging message or communication. Transmission of these paging messages across multiple communication protocols may occur in a particular defined order, depending on the parameters of the communication network. In at least one example, an SM-IWF (such as SM-IWF 212) may be configured to coordinate transmission of paging messages across multiple communication protocols in a particular order, depending on various factors, such as the communication protocols supported on a satellite. For example, a paging message may be sent using NTN-IoT. The paging message may specify that a message or call is available for the UE. The transmission of the paging message may be repeated a certain number of cycles to the UE using NTN-IoT. If the UE fails to acknowledge the paging message, then the SM-IWF may coordinate transmission of the paging message using other available communication protocols, such as NTN-NR or VoLTE. Once the paging message is acknowledged, the communication network may coordinate transmission of messages using the same protocol or may coordinate with the UE for transmission of the intended messages using a different protocol.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a segment” includes a plurality of such segments, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, “media content,” “media program,” “multimedia content,” “content,” or variants thereof should be understood as referring to any audiovisual programming or content in any streaming, file-based, or another format. The media content generally includes data that, when processed by a media player or decoder, allows the media player or decoder to present a visual and/or audio representation of the corresponding program content to a viewer (i.e., the user of a client device including the media player or decoder). In one or more examples, a media player can be realized as a piece of software that plays multimedia content (e.g., displays video and plays audio).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for performing hybrid satellite communications, the method comprising:
registering, by a computer system, user equipment (UE) for communication via a non-terrestrial network (NTN) Internet-of-Things (IoT) carrier;
registering, by the computer system, the UE for communication via an NTN New Radio (NR) carrier;
registering, by the computer system, to perform information management system (IMS) messaging via the NTN-NR carrier;
registering, by the computer system, to perform short message service (SMS) messaging over non-access stratum (NAS) via the NTN-IoT carrier; and
performing messaging with the UE via the NTN-IoT carrier and the NTN-NR carrier.

2. The method for performing hybrid satellite communications of claim 1, wherein the NTN-IoT carrier is located in a guard band of a frequency allocation used for the NTN-NR carrier.

3. The method for performing hybrid satellite communications of claim 2, wherein a frequency range within the guard band is reserved to separate the NTN-IoT carrier from an adjacent frequency allocation.

4. The method for performing hybrid satellite communications of claim 1, further comprising selecting between the NTN-IoT carrier and the NTN-NR carrier based on bandwidth.

5. The method for performing hybrid satellite communications of claim 1, wherein messaging is performed by the UE via the NTN-IoT carrier unless user input is received to the select the NTN-NR carrier.

6. The method for performing hybrid satellite communications of claim 1, wherein registering the UE for communication via the NTN-IoT carrier and the NTN-NR carrier is performed in response to the UE detecting that communication with a terrestrial network (TN) is not available.

7. The method for performing hybrid satellite communications of claim 1, wherein registering to perform IMS messaging via the NTN-NR carrier comprises a satellite messaging interworking function (SM-IWF) system performing registration.

8. The method for performing hybrid satellite communications of claim 7, further comprising:
notifying, by the SM-IWF system, a sender of a message that video content was unable to be delivered to the UE.

9. The method for performing hybrid satellite communications of claim 8, further comprising:
storing, by the SM-IWF system, the video content for later delivery to the UE via a terrestrial network.

10. The method for performing hybrid satellite communications of claim 7, further comprising:
parsing a received message to obtain only an SMS component;
delivering only the SMS component to the UE; and
storing an undeliverable component of the received message by the SM-IWF system for later delivery to the UE via either the NTN-NR carrier or a terrestrial network.

11. A system for performing hybrid satellite communications, the system comprising:
one or more processors; and
a non-transitory processor-readable medium comprising processor-readable instructions configured to cause the one or more processors to:
register user equipment (UE) for communication via a non-terrestrial network (NTN) Internet-of-Things (IoT) carrier;
register the UE for communication via an NTN New Radio (NR) carrier;
register to perform information management system (IMS) messaging via the NTN-NR carrier;
register to perform short message service (SMS) messaging over non-access stratum (NAS) via the NTN-IoT carrier; and
perform messaging with the UE via the NTN-IoT carrier and the NTN-NR carrier.

12. The system for performing hybrid satellite communications of claim 11, wherein the NTN-IoT carrier is located in a guard band of a frequency allocation used for the NTN-NR carrier.

13. The system for performing hybrid satellite communications of claim 12, wherein a frequency range within the guard band is reserved to separate the NTN-IoT carrier from an adjacent frequency allocation.

14. The system for performing hybrid satellite communications of claim 11, wherein the one or more processors are further configured to select between the NTN-IoT carrier and the NTN-NR carrier based on bandwidth.

15. The system for performing hybrid satellite communications of claim 11, wherein messaging is performed by the UE via the NTN-IoT carrier unless user input is received to select the NTN-NR carrier.

16. The system for performing hybrid satellite communications of claim 11, wherein the registration of the UE for communication via the NTN-IoT carrier and the NTN-NR carrier is performed in response to the UE detecting that communication with a terrestrial network (TN) is not available.

17. The system for performing hybrid satellite communications of claim 11, further comprising a satellite messaging interworking function (SM-IWF) system, wherein registering to perform IMS messaging via the NTN-NR carrier comprises the SM-IWF system performing registration.

18. The system for performing hybrid satellite communications of claim 17, wherein the instructions are further configured to cause the one or more processors to: notify, via the SM-IWF system, a sender of a message that video content was unable to be delivered to the UE.

19. A non-transitory processor-readable medium comprising processor-readable instructions configured to cause one or more processors to:
register user equipment (UE) for communication via a non-terrestrial network (NTN) Internet-of-Things (IoT) carrier;
register the UE for communication via an NTN New Radio (NR) carrier;
register to perform information management system (IMS) messaging via the NTN-NR carrier;
register to perform short message service (SMS) messaging over non-access stratum (NAS) via the NTN-IoT carrier; and
perform messaging with the UE via the NTN-IoT carrier and the NTN-NR carrier.

20. A non-transitory processor-readable medium comprising processor-readable instructions configured to cause one or more processors to:
parse a received message to obtain only an SMS component;
deliver only the SMS component to a user equipment (UE) via a non-terrestrial network (NTN) Internet-of-Things (IoT) carrier; and
store an undeliverable component of the received message by a satellite messaging interworking function (SM-IWF) system for later delivery to the UE via either an NTN New Radio (NR) carrier or a terrestrial network.
